(19) United States
(12) Patent Application Publication
(10) Pub. No.: US 2020/0126019 A1
(43) Pub. Date: Apr. 23, 2020

(54) CALCULATING PROCESS PRIORITIES BASED ON RUN-TIME AND DESIGN-TIME ATTRIBUTES

(71) Applicant: SAP SE, Walldorf (DE)

(72) Inventors: Rashmi Vanaja, Bangalore (IN); Jai Vignesh R, Chennai (IN)

(21) Appl. No.: 16/166,854

(22) Filed: Oct. 22, 2018

(51) Int. Cl. G06Q 10/06; G06F 17/16; H04L 12/24

(52) U.S. Cl. CPC G06Q 10/06393; G06Q 10/0637; H04L 41/22; H04L 41/5009; G06F 17/16

(57) ABSTRACT

Disclosed herein are system, method, and computer program product embodiments for calculating priorities for processes and key performance indicators in a process monitoring tool by considering design time and run time parameters. The process monitoring tool may calculate a priority for the processes that considers the status, category, prevalence, and preference of the KPIs in that process, enabling users to determine which problems to devote resources towards remedying. The process monitoring tool may display the tracked processes and key performance indicators sorted by the calculated priorities.

### BACKGROUND

Speaking broadly, individuals in an organization may engage in a variety of behaviors involving interactions between and among other individuals, objects, and technological components. These behaviors may be organized conceptually into processes, i.e., a set of activities that accomplish specific organizational goals. An organization may manage and monitor important and germane processes with a process monitoring tool. A process monitoring tool may allow the organization to identify issues that arise within relevant organizational processes and devote appropriate resources towards remedying the problems.

### BRIEF DESCRIPTION OF THE DRAWINGS

The accompanying drawings, which are incorporated herein and form a part of the specification, illustrate embodiments of the present disclosure and, together with the description, further serve to explain the principles of the disclosure and to enable a person skilled in the art(s) to make and use the embodiments.

FIG. 1 is a schematic block diagram showing an example system including a monitoring tool, according to some embodiments.

FIGS. 2A-2B are example screen displays of an exemplary monitoring tool, according to some embodiments.

FIG. 3 is a schematic block diagram showing an example system including systems and processes, according to some embodiments.

FIGS. 4A-4B are example schematic block diagrams showing organizational processes and key performance indicators, according to some embodiments.

FIG. 5 is a flowchart illustrating a method of calculating priorities for organizational processes, according to some embodiments.

FIG. 6 is a flowchart illustrating a method of calculating priorities for key performance indicators, according to some embodiments.

FIG. 7 is a flowchart illustrating a method of calculating a priority for a key performance indicator across organizational processes, according to some embodiments.

FIG. 8 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for effectively calculating priorities among processes in a process monitoring tool.

A process monitoring tool may allow an organization to track the performance and viability of the processes that impact the organization. The organizational processes may include a series of activities directed towards achieving a goal. Such steps may include a variety of behaviors performed by individuals inside and outside of the organization, actions performed by machines, computers, or technological components employed by the organization, and other suitable activities. Initiation of one step in the organizational process may depend upon completion of a prior step, but steps may also be performed in parallel. Example organizational processes may include receiving orders from customers, generating and sending invoices to customers, setting a budget for a time period, onboarding a new employee, rolling out a new product, and many other suitable processes that will vary from industry to industry and among organizations within an industry.

The discrete steps, modules, and/or actions completed within an organizational process may be monitored with one or more key performance indicators (KPI). In some embodiments, a KPI may be defined as a data-driven indicator drawn from a wide-array of data-driven applications, systems, and/or sources. A KPI may be used to monitor a component in an organization's processes, and an organization may tailor, configure, and deploy customized KPIs to monitor their unique processes. A KPI may include a title, a data source, formulas, calculations, benchmarks, thresholds, other descriptive information, and various other metadata. A KPI may refresh periodically to provide a real-time or near-real time indication of the monitored entity, perhaps through interactions with an application programming interface provided by an ancillary system. A KPI may display an integer, decimal, floating point number, string, or other text for review by a user. A KPI may also display a line graph, bar graph, chart, or other visualization of the monitored data.

A KPI may also include a threshold that determines the KPI's status with respect to the underlying data. A threshold frames levels of concern regarding monitored components. A threshold may define ranges of values corresponded to each level of concern. For a simple example, an organization may have a help desk response process. The organization could set a KPI to monitor the number of open, unanswered help requests. The organization could then set a threshold, e.g., the integer 30, to define a high level of concern. If the number of open tickets exceeds this threshold, a high level of concern would be in effect, and the status may be indicative of an issue that needs to be resolved.

In an embodiment, a user may set thresholds corresponding to colors in order to visually indicate a problem's severity in the process monitoring tool. In an example embodiment, a “red” threshold may be set to define an issue that is critical and needs immediate attention, a “yellow” threshold may be set to define an issue that could affect a process in the near future, and a “green” threshold may be set for processes that are performing acceptably. A “grey” indicator may occur when no monitoring information is available for a KPI. These thresholds may be fully customizable both across KPIs and customers.

In an embodiment, a KPI may be a business KPI or a technical KPI. A business KPI may monitor and track a process's efficiency. Examples of business KPIs include: “Number of Sales Documents Created Per Day,” “Number of Open Sales Orders,” “Incomplete Sales Documents,” or the above-described example of monitoring the number of open help desk tickets. A technical KPI may monitor the technical health of systems on which a process depends. Examples of technical KPIs include: “ABAP System HTTP Availability,” “Transaction Response Times,” “Number of Long Running Messages,” “Number of Jobs In Status ERROR,” “Number of Messages Waiting For Delivery,” etc. KPIs may be associated with a process or multiple processes, i.e. a KPI may be a “shared” among processes. For example, a technical KPI may monitor a shared component or resource (e.g., a server or database) that is integral to multiple processes. Some KPIs may be standardized, other KPIs may be customized by and unique to an organization.

To provide an example illustrating these concepts, a process of “Order to Cash,” may track orders and receipt of payment for those orders. In this example, numerous KPIs may be created and/or enabled to monitor the “Order to Cash” process. A business KPI may be created to monitor the number of open and unanswered orders. A user may configure this KPI to have a threshold set to throw a red status if there are more than 50 open orders, a yellow status if there are more than 30 open orders, and a green status in all other cases. A technical KPI may be created to monitor the CPU performance on a server that processes the orders. This technical KPI could be configured to throw a red alert if the CPU utilization stays above 90%, a yellow alert if above 75%, and green in all other cases. Numerous other suitable KPIs could be created or deployed in order to appropriately monitor the “Order to Cash” process. In this example, a user may want to view the tracked information about the “Order to Cash” process in a centralized location alongside all other configured processes.

Accordingly, a process monitoring tool may display process information and KPI information in a dashboard or visualization. Such a visualization may include configured status information across the processes and KPIs. For example, a user may login and view processes with a status indicator for each KPI configured in each process. A user may examine a particular process to examine more detailed information about the KPIs in the process.

When examining multiple processes and KPIs, more than one process and/or KPI may be experiencing problems, exceeding configured thresholds, and/or displaying as red or yellow. In such a happenstance, a user may need to determine how best to devote their organizational resources to most efficiently resolve concurrent problems. A user may need to determine which process or processes to focus on first and which KPIs within the process(es) to troubleshoot in order to maximize the impact of remedying a problem. The monitoring tool may determine priorities among the processes and KPIs and sort and visually arrange the processes and KPIs according to the priorities.

A priority for an organizational process may consider both runtime factors and design time factors. A runtime factor may be a factor associated with the KPIs by the monitoring tool during execution or refreshed via interaction with organizational systems in real-time or near-real time. Examples of a runtime factor include the KPI status as determined by comparing the underlying data to the threshold. A design time factor may be associated with a KPI or process during configuration. Examples of design time factors include: a preference assigned to the KPI, a category assigned to the KPI, the number of shared KPIs assigned to a process, process prioritization, and a predefined order.

Accordingly, embodiments of this disclosure are configured to effectively determine priorities of status indicators for organizational processes and KPIs in an organizational process monitoring tool.

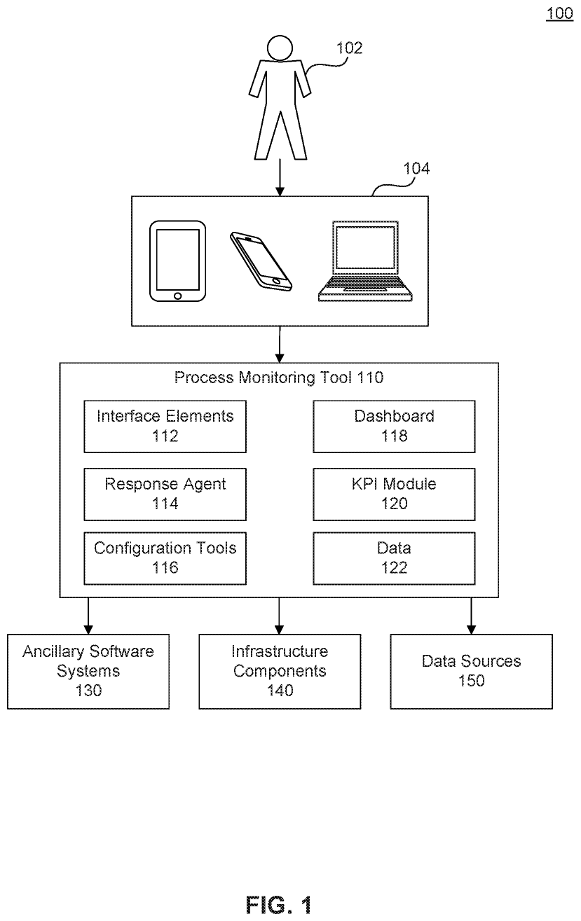

FIG. 1 illustrates a schematic block diagram showing an example system 100, according to some embodiments. System 100 may include user 102, device 104, process monitoring tool 110, ancillary systems 130, infrastructure components 140, and data sources 150.

User 102 may be an individual or entity monitoring organizational processes. User 102 may be a member of a business, organization, or other suitable group using process monitoring software to perform organizational tasks. User 102 may be an individual using such applications for personal pursuits. User 102 may be a human being, but user 102 may also be an artificial intelligence construct. User 102 may employ, i.e., connect to, a network or combination of networks including the Internet, a local area network (LAN), a wide area network (WAN), a wireless network, a cellular network, or various other types of networks as would be appreciated by a person of ordinary skill in the art.

Device 104 may be a personal digital assistant, desktop workstation, laptop or notebook computer, netbook, tablet, smart phone, mobile phone, smart watch or other wearable, appliance, part of the Internet-of-Things, and/or embedded system, to name a few non-limiting examples, or any combination thereof. Although device 104 is illustrated in the example of FIG. 1 as a single computer, one skilled in the relevant art(s) will understand that device 104 may represent two or more computers in communication with one another. Therefore, it will also be appreciated that any two or more components of system 100 may similarly be executed using some or all of the two or more computers in communication with one another.

Process monitoring tool 110 may track, monitor, and analyze processes and present an interface to users to examine, troubleshoot, and debug processes and KPIs. Process monitoring tool 110 may present information about processes and KPIs based on configured statuses, thresholds, and preferences. For example, user 102 may view in process monitoring tool 110 a color indicator for each configured process where the color provides an indicator of the processes' currently viability. Process monitoring tool 110 may calculate a priority for and among the processes and visually arrange the processes according to the priority. In one embodiment, process monitoring tool 110 may monitor applications in a cloud solution, where multiple customers are using the same system using multi-tenancy or sharing the same data center. Process monitoring tool 110 may include interface elements 112, response agent 114, configuration tools 116, dashboard 118, KPI module 120, and data 122.

Interface elements 112 may provide components that allow process monitoring tool 110 to render and present a user interface for view by user 102 with device 104. Interface elements 112 may include appropriate stylesheets and design formats to shape, for example, the display format of data retrieved by process monitoring tool 110. Interface elements 112 may include a JavaScript library or other user interface library to facilitate dynamic interactions between user 102 and process monitoring tool 110. Interface elements 112 may include a development toolkit facilitating the building and deployment of HTML5 applications or mobile applications.

Response agent 114 may be a suitable application server, web server, or other mechanism for responding to traffic received via appropriate communication channels. Response agent 114 may run on premise, for instance, in a hosted environment or data center, or on the cloud. Response agent 114 may be implemented using an advanced business application programming language or other suitable high-level programming language, e.g., C/C++, Java, Perl, etc. Response agent 114 may be divided into a presentation layer (e.g., ASP, JSP, BSP, etc.), business-logic layer (e.g., J2EE runtime environment, java beans, etc.), integration layer (connecting to other application servers or APIs), connectivity layer (e.g., HTTP, HTTPS, SSL, etc.), persistence layer (e.g., SQL, etc.), and other suitable layers. Response agent 114 may authenticate incoming web traffic, interact with backend systems to formulate appropriate responses, and return responses to user 102.

Configuration tools 116 may allow user 102 to configure organizational processes, KPIs, thresholds, preferences, and other details within process monitoring tool 110. Configuration tools 116 may allow user 102 to monitor processes tailored for their organization. Configuration tools 116 may allow user 102 to design, implement, configure, and deploy KPIs within and among the processes. For example, configuration tools 116 may allow user 102 to specify the data source from which to draw KPI-relevant information. Configuration tools 116 may allow user 102 to set preferences, statuses, and thresholds across the KPIs contained in the processes.

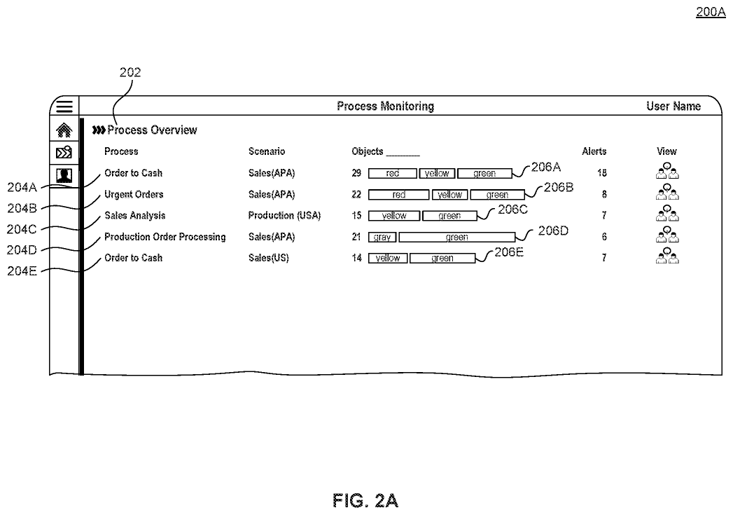

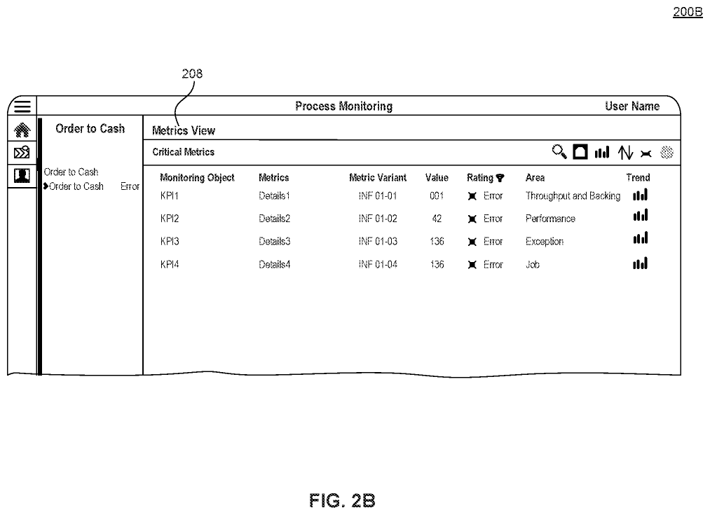

Dashboard 118 may allow user 102 to view the current statuses of the processes and KPIs within process monitoring tool 110. Dashboard 118 may include a process view, i.e., a view that displays the processes being monitored by process monitoring tool 110. Dashboard 118 may include a metrics view, i.e., a view that displays KPIs in process monitoring tool 110. Dashboard 118 is demonstrated in further detail below with reference to FIGS. 2A and 2B.

KPI module 120 may facilitate the creation, storage, and refreshing of data driven indicators drawn from system applications, i.e., KPIs. KPI module 120 may deploy and employ application programming interfaces to connect to various system resources in order to refresh underlying data. KPI module 120 may compare data retrieved from associated systems to configured thresholds to determine a status for the KPI.

Data 122 may store a variety of information relevant to the organizational processes, KPIs, user permissions, and other information used by process monitoring tool 110. Data 122 may employ a relational database, a NoSQL database or other horizontally scaling database, or any other database adhering to a suitable database design methodology. In an embodiment, data 122 may leverage a centralized storage area network (SAN), network-attached storage (NAS), redundant array of independent disks, and/or any other configuration of storage devices to supply sufficient storage capacity to store database tables and supporting structures. Sufficient storage may alternatively exist in any other physically attached magnetic storage, cloud storage, or additional storage medium. In an embodiment, process monitoring tool 110 may deploy a hard-disk interface, such as ATA, SATA, SCSI, SAS, and/or fibre for interfacing with storage mediums in data 122. Data 122 may be stored in tables adhering to a row-based or columnar methodology or design.

Ancillary systems 130 may be systems harnessed by an organization to accomplish steps in an organizational process. Examples of ancillary systems 130 include: enterprise resource planning tools, supplier relationship management tools, customer relationship management tools, supply chain management tools, product lifecycle management tools, transportation management systems, and a panoply of other suitable systems. Ancillary systems 130 may use various technological components, e.g., application servers, databases, etc., but this is not necessarily so. Ancillary systems 130 may involve human activities, e.g., manually check-ins or sign-offs.

Infrastructure components 140 may be technical resources commissioned to accomplish organizational processes. Infrastructure components 140 may include computers, application servers, particular processes or processors, memory, storage devices, file servers, database servers, and other technologies. Infrastructure components 140 may be housed internally and managed by an organization, but infrastructure components 140 may also be managements systems in the cloud or externally. Infrastructure components 140 may be coextensive with and/or distinct from ancillary systems 130.

Data sources 150 may be additional data sources storing data related to the organizational processes. Data sources 150 may harness relational databases, spreadsheets, text files, or other suitable data storage approaches. Data sources 150 may employ paper storage mechanisms or other filing approaches.

FIGS. 2A-2B are examples of screen display 200 of an exemplary process monitoring tool, according to some embodiments. The screen displays provided in FIGS. 2A-2B are merely exemplary, and one skilled in the relevant art(s) will appreciate that many approaches may be taken to provide a suitable screen display 200 in accordance with this disclosure.

Process overview 202 may present an overview, summary, or synopsis of the processes defined by an organization and monitored in process monitoring tool 110. In an embodiment, process monitoring tool 110 may employ interface elements 112 to fashion a visualization of the processes depicting relevant KPI statuses along with other descriptive information. In the embodiment displayed in exemplary screen display 200, the display includes a number of alerts. One skilled in the arts will understand that many suitable visualizations may be designed and deployed.

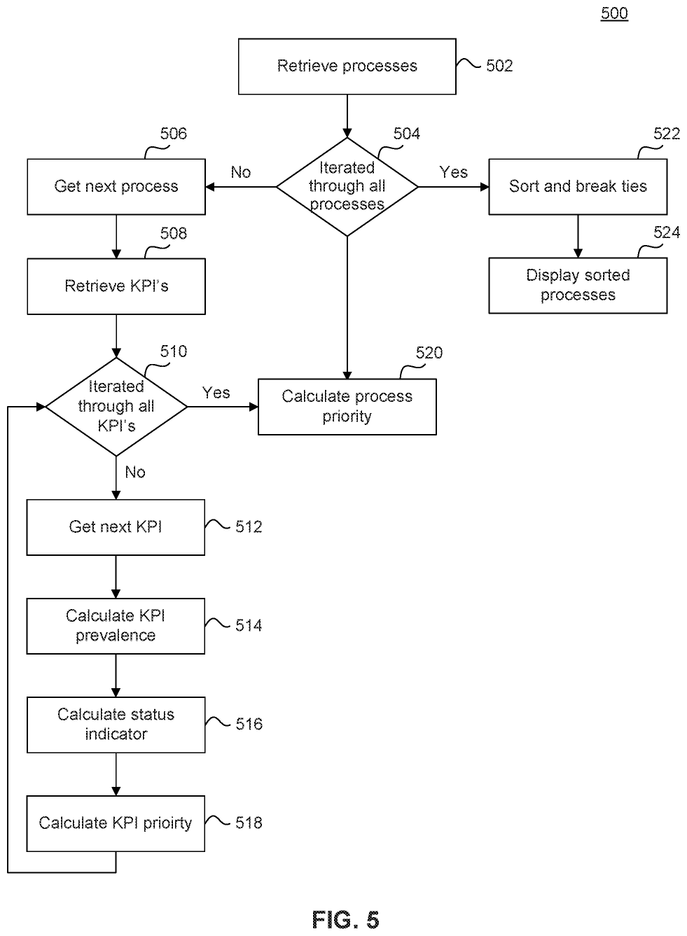

Process row 204 may depict an organizational process configured within process monitoring tool 110. Exemplary illustrations of process row 204 in process overview 202 include “Order to Cash,” “Urgent Orders”, “Sales Analysis,” and “Production Order Processing.” In an embodiment, user 102 may click, select, or otherwise enter an input indicating a selection of a particular process in order to be routed to a view with further details about that particular process row 204, i.e. to metrics view 208. The order in which each process row 204 displays may be arranged by process monitoring tool 110 according to a calculated priority, as described in further detail below with reference to FIGS. 5-7.

Status 206 may present a status, i.e., a performance/vitality/health indicator for each process row 204. Status 206 may display a number of KPIs included in that process. Status 206 may also present a status visualization for each KPI included in that organizational process. In an embodiment, status 206 may group the KPIs into colors, e.g., a high priority issue may display as red, a mid-priority issue as yellow, and a non-issue as green. Status 206 may include the counts of KPIs in each color. Process monitoring tool 110 may include links via status 206 to the sorted and filtered KPI data, e.g., if user 102 selects the red KPIs for a process, process monitoring tool 110 may route user 102 to a page displaying on those KPIs.

Metrics view 208 may provide an overview of the KPIs within a particular process row 204. In an embodiment, user 102 may enter metrics view 208 by selecting particular process row 204 in process overview 202. Metrics view 208 may display a KPI name and other identifying characteristics of the KPIs. Metrics view 208 may also display a rating, i.e., a KPI's most recent reading as compared to the configured thresholds. Metrics view 208 may include appropriate sorting, filtering, and search mechanisms to explore the KPIs. Metrics view 208 may include additional analytical or visualization tools.

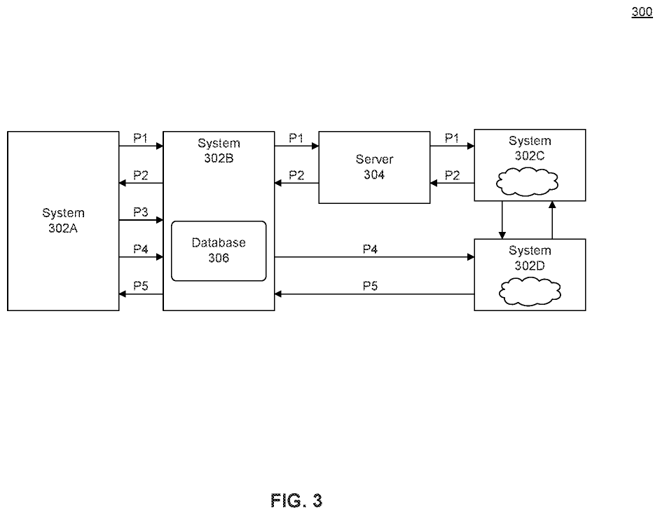

FIG. 3 is a schematic block diagram showing an example environment 300 including an organization's systems and processes, according to some embodiments.

System 302 may be a tool used in the completion of an activity in an organizational process. System 302 may provide an application programming interface through which to receive information requests and provide responses. Examples of system 302 include sales applications, invoicing systems, shipping systems, employee management tools, tasklists, etc. System may also include file server 304 and database 306.

FIG. 3 illustrates the dependencies of multiple processes upon one or more systems leveraged by the organization. In the illustration in FIG. 3, a process “P1” makes use of system 302A, system 302B, file server 304, and system 302C. A separate process “P2” makes use of these same resources, however, “P2” uses the resources in a different order. “P3” uses system 302A and system 302B. “P4” and “P5” may implicate system 302B and system 302D.

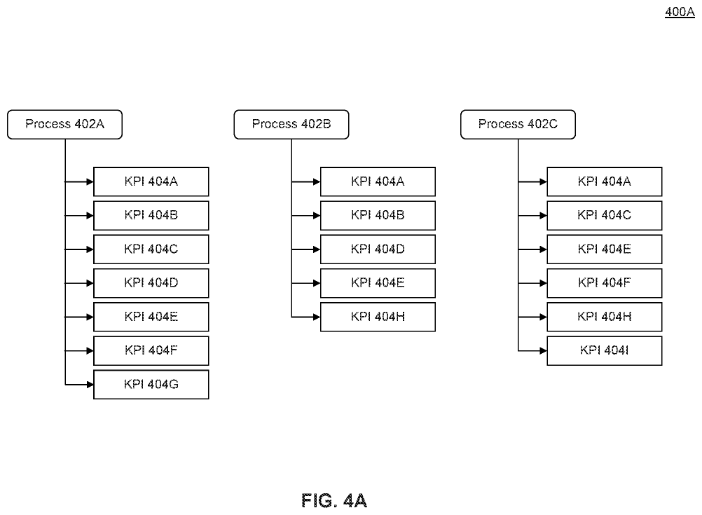

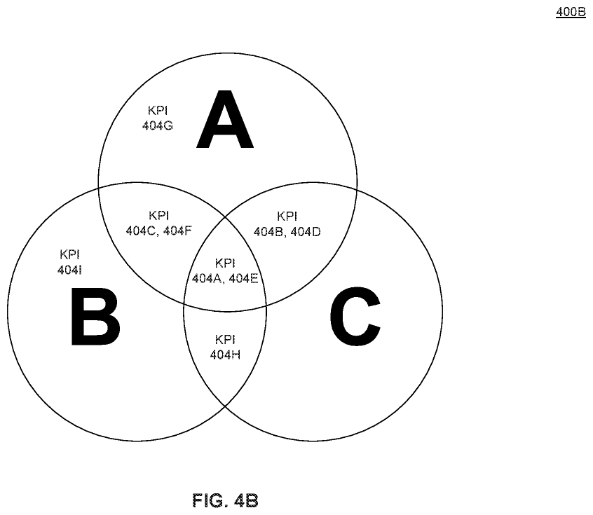

FIGS. 4A-4B are example schematic block diagrams showing organizational processes and key performance indicators, according to some embodiments. FIGS. 4A-4B illustrate an example scenario depicting relationships between processes and KPIs. This example is meant to be illustrative and is in no way limiting.

Process 402 may be an organizational process configured within process monitoring tool 110. Process 402 may include one or more steps, activities, or actions directed towards achieving a goal. These actions in process 402 may be behaviors performed by individuals inside and outside of the organization as well as actions performed by machines, computers, or technological components employed by the organization.

KPI 404 may be a data-driven indicator drawn from a wide-array of data-driven applications and/or systems, as configured by user 102 of process monitoring tool 110. KPI 404 may track a key component in an organization's processes. KPI 404 may be associated with one or more processes.

In the exemplary illustration in FIG. 4A, process 402A includes and is associated with KPI 404A, KPI 404B, KPI 404C, KPI 404D, KPI 404E, KPI 404F, and KPI 404G. Process 402B includes and is associated with KPI 404A, KPI 404B, KPI 404D, KPI 404E, and KPI 404H. Process 402A includes and is associated with KPI 404A, KPI 404C, KPI 404E, KPI 404F, KPI 404H, and KPI 404I.

FIG. 4B presents an alternate visualization of the dependencies in FIG. 4A in the form of a Venn diagram. FIGS. 4A and 4B illustrate the relatedness between and interdependencies among KPIs and processes in process monitoring tool 110.

FIG. 5 is a flowchart illustrating a method of calculating priorities for processes, according to some embodiments. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art(s).

In 502, process monitoring tool 110 may retrieve information about processes monitored by an organization from data 122. Process monitoring tool 110 may retrieve this information in response to a request from user 102 received by responsive agent 114 to view the prioritized processes in process monitoring tool 110. Process monitoring tool 110 may retrieve a catalog, list, hash, array, other suitable data structure, or other appropriately formed construct from data 122. Process monitoring tool 110 may retrieve the process names, associated KPIs, configured preferences for the processes, details of open support tickets, and a bevy of other suitable information.

In 504, process monitoring tool 110 may determine if the processes retrieved in 502 have been iterated through, i.e., a priority was calculated for the processes retrieved in 502. If the processes retrieved in 502 have been iterated through, then method 500 proceeds to 522. If processes remain to be considered, then method 500 proceeds to 506.

In 506, process monitoring tool 110 may step to, consider, or load the next process among the processes retrieved in 502. The order in which the processes are traversed is flexible, and the processes may be traversed sequentially, e.g., alphabetically, or non-sequentially, e.g., in random order. This retrieved process may be referred to below as the current process.

In 508, process monitoring tool 110 may retrieve KPIs associated with the current process. Process monitoring tool 110 may employ KPI module 120 to retrieve information about the KPIs from data 122. Process monitoring tool 110 may retrieve the KPIs in a catalog, list, hash, array, or other suitable data structure. The KPI information retrieved may include KPI names and descriptors, status information, KPI preferences and thresholds, and other KPI-related information.

In 510, process monitoring tool 110 may determine if the KPIs retrieved in 508 related to the current process have been iterated through, i.e. a priority was calculated for the KPIs retrieved in 508. If the KPIs have been iterated through, then method 500 proceeds to 520. If KPIs remain to examine, then method 500 proceeds to 512.

In 512, process monitoring tool 110 may step to, consider, or load the next KPI from among the KPIs retrieved in 508. The order in which the KPIs are traversed is flexible, and KPIs may be traversed in any suitable order. This retrieved KPI may be referred to below as the current KPI.

In 514, process monitoring tool 110 may calculate a KPI prevalence. A KPI prevalence may be calculated by considering the number of processes that the KPI is assigned to across the monitored processes. This KPI prevalence may be referred in calculations below as N:
N=Number of Processes Containing The Current KPI

In 516, process monitoring tool 110 may calculate a status indicator. This status indicator may consider the status of the KPI (as recently refreshed from ancillary systems 130, infrastructure components 140 and/or data source 150) as well as a category assigned to the KPI at design time. The available categories and statuses attributable to the KPI may differ between and within deployments. In an embodiment, the status indicator may be determined by looking up the status and category in an appropriately designed default matrix. A merely illustrative example of such a matrix follows:

| | | | | Data | Ex- | Perfor- |
|---|---|---|---|---|---|---|
| | Throughput | Job | Interface | Consistency | ception | mance |
| Red | 19 | 20 | 21 | 22 | 23 | 24 |
| Yellow | 13 | 14 | 15 | 16 | 17 | 18 |
| Grey | 7 | 8 | 9 | 10 | 11 | 12 |
| Green | 1 | 2 | 3 | 4 | 5 | 6 |

The categories, statuses, and values provided in this example default matrix are merely exemplary and the default matrix may use more, less, or different categories, statuses, and values in other embodiments. In this example, if the current KPI is in a red status and the category for the current KPI is “Performance,” then the status indicator for the current KPI may be “24.” This value may be referred to below as the current status:

current status=f(Status,Category)

In 518, process monitoring tool 110 may calculate a KPI priority. The KPI priority may be derived by multiplying N by the current status indicator. The initial KPI priority may be:

W_{KPI}=N×f(Status,Category)

The initial KPI may be further modified by multiplying the initial KPI by a KPI preference set at design time. The KPI preference may differ across the examined KPIs, as determined by user 102 when configuring the KPI at design time. A KPI preference may be set in textual or numerical values. In an embodiment, process monitoring tool 110 may crosswalk textual values to a numerical value using an approach evidenced in this matrix:

| Preference | KPI Preference |
|---|---|
| Very High | 4 |
| High | 3 |
| Medium | 2 |
| Low | 1 |

Where numerical values are provided, process monitoring tool 110 may determine the KPI preference by consulting a table such as:

| Preference | KPI Preference |
|---|---|
| 1 | n |
| 2 | n − 1 |
| 3 | . . . |
| 4 | 5 |
| 5 | 4 |
| . . . | 3 |
| n − 1 | 2 |
| n | 1 |

Thus, the KPI priority may additionally consider the KPI preference (KPI_{Pref}) to determine the KPI priority:

W′_{KPI}=(W_{KPI}*KPI_{Pref})

In 520, process monitoring tool 110 may calculate a process priority for the current process. The process priority may consider the sum of the weights of the KPIs associated with the current process as calculated in 518. In one embodiment, the process priority may be calculated by:

W_{PROC}=W1′_{KPI}=W2′_{KPI}+W3′_{KPI}+ . . . +Wn′_{KPI}

The process priority may further consider a process preference as assigned at design time:

W′_{PROC}=W_{PROC}*Proc_{PREF}

The process preference (Proc_{PREF}) may consult similar matrices as those illustrated above for the KPI preference. However, the process preference may be configured at the process level.

In 522, process monitoring tool 110 may sort the processes by process priority and break any ties. Process monitoring tool 110 may use any suitable sorting method to sort the processes by their calculated priorities. Process monitoring tool 110 may break ties by, for example, considering if an open support ticket exists for the similarly weighted processes. If the tie remains, process monitoring tool 110 may consider the order in which the process was added, the time of the most recent refresh, alphabetical order, or any other suitable approach to break ties.

In 524, process monitoring tool 110 may display the sorted processes according to the process priorities determined in 520. Process monitoring tool 110 may invoke interface elements 112 and/or responsive agent 114 to form an appropriate visualization of the sorted processes, as described above with reference to FIGS. 2A-2B. Thus, user 102 may view the processes in process monitoring tool 110 sorted by an indication of priority that considers the status, category, prevalence, and preference of the KPIs in that process, enabling user 102 to determine which problems to devote resources towards remedying.

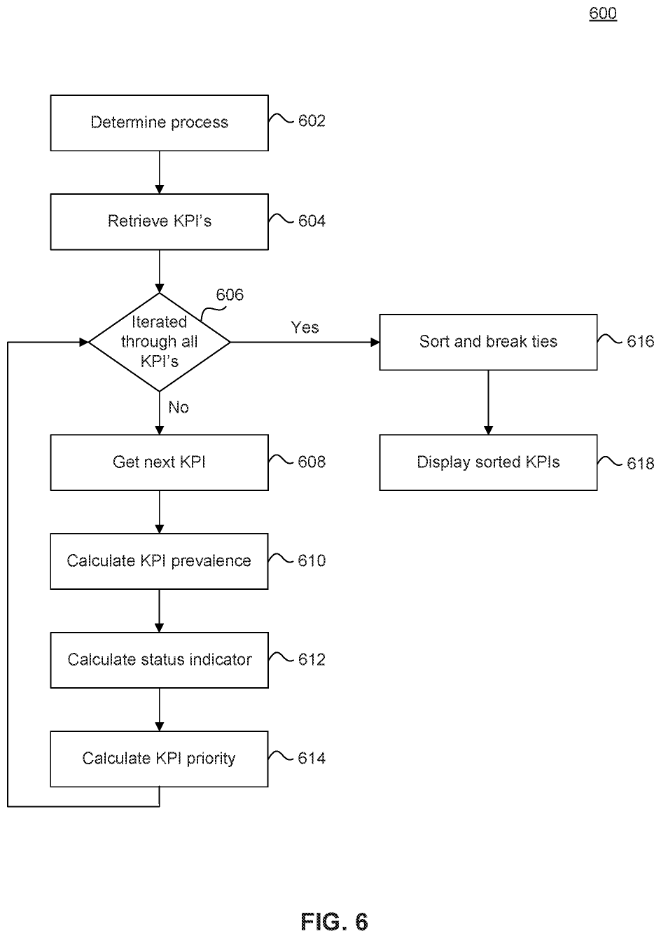

FIG. 6 is a flowchart illustrating a method of calculating priorities for key performance indicators, according to some embodiments. Method 600 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 6, as will be understood by a person of ordinary skill in the art(s).

In 602, process monitoring tool 110 may determine a particular process to examine. Process monitoring tool 110 may receive a selection from user 102 of a particular process displayed using interface elements 112. For example, user 102 may indicate a selection of a process in a screen display such as process overview 202. User 102 may indicate a selection using a click, a tap, voice command, or other suitable gesture. This particular process may be referred to below as the determined process. In an alternate embodiment, process monitoring tool 110 may determine the process to examine automatically, algorithmically, randomly, or using any other suitable method of selecting a process to examine.

In 604, process monitoring tool 110 may retrieve KPIs associated with the determined process. Process monitoring tool 110 may employ KPI module 120 to retrieve information about the KPIs from data 122. Process monitoring tool 110 may retrieve the KPIs in a catalog, list, hash, array, or other suitable data structure. The KPI information retrieved may include KPI names and descriptors, status information, KPI preferences and thresholds, and other KPI-related information.

In 606, process monitoring tool 110 may determine if the KPIs retrieved in 604 related to the determined process have been iterated through, i.e. the KPIs have had a priority calculated. If the KPIs have been iterated through, then method 600 proceeds to 616. If KPIs remain to examine then method 600 proceeds to 608.

In 608, process monitoring tool 110 may step to, consider, or load the next KPI from among the KPIs retrieved in 604. The order in which the KPIs are traversed is flexible, and KPIs may be traversed in any suitable order. This retrieved KPI may be referred to below as the current KPI.

In 610, process monitoring tool 110 may calculate a KPI prevalence. A KPI prevalence may be calculated by considering the number of processes that the KPI is assigned to across the monitored processes. This KPI prevalence may be referred in calculations below as N:
N=Number of Processes Containing The Current KPI

In 612, process monitoring tool 110 may also calculate a status indicator. This indicator may consider the status of the KPI (as recently refreshed from ancillary systems 130, infrastructure components 140 and/or data source 150) as well as a category assigned to the KPI at design time. In an embodiment, the status indicator may be determined by looking up the status and category in an appropriately designed matrix. An example of such a matrix is displayed above with reference to FIG. 5. This value may be referred to below as the current status:

current status=f(Status,Category)

In 614, process monitoring tool 110 may calculate a KPI priority. An initial KPI priority may be derived by multiplying N by the current status indicator. The initial KPI priority may be:

W_{KPI}=N×f(Status,Category)

The initial KPI may be further modified by multiplying the initial KPI by a KPI preference set at design time. The KPI preference may differ across the examined KPIs, as determined by user 102 when configuring the KPI at design time. A KPI preference may be set in textual or numerical values. Example matrices for determining a value for a KPI preference are included above with reference to FIG. 5. Thus, the KPI priority may additionally consider the KPI preference (KPI_{Pref}) to determine the KPI priority:

W′_{KPI}=(W_{KPI}*KPI_{Pref})

In 616, process monitoring tool 110 may sort the KPIs by the KPI priority determined in 614 and break any ties. Process monitoring tool 110 may use any suitable sorting method to sort the KPIs by their calculated priorities. Process monitoring tool 110 may break ties by, for example, considering if an open support ticket exists for the KPI. If the tie remains, process monitoring tool 110 may consider the order in which the KPI was added, the time of the most recent refresh, alphabetical order, or any other suitable approach to break ties.

In 618, process monitoring tool 110 may display the sorted KPIs processes according to the KPI priorities determined in 614. Process monitoring tool 110 may invoke interface elements 112 and/or responsive agent 114 to form an appropriate visualization of the sorted KPIs. Thus, user 102 may view the KPIs in process monitoring tool 110 sorted by an indication of priority that considers the status, category, prevalence, and preference of the KPIs for a particular selected or otherwise determined process.

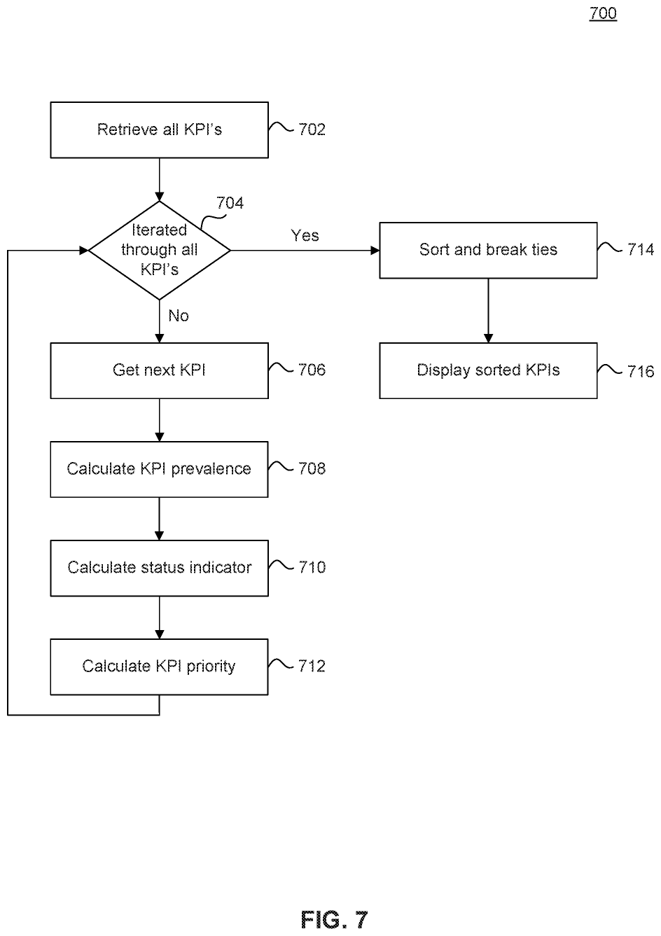

FIG. 7 is a flowchart illustrating a method of calculating a weight for key performance indicator across processes, according to some embodiments. Method 700 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 7, as will be understood by a person of ordinary skill in the art(s).

In 702, process monitoring tool 110 may retrieve the KPIs monitored and tracked in process monitoring tool 110. Process monitoring tool 110 may employ KPI module 120 to retrieve information about the KPIs from data 122. Process monitoring tool 110 may retrieve the KPIs in a catalog, list, hash, array, or other suitable data structure. The KPI information retrieved may include KPI names and descriptors, status information, KPI preferences and thresholds, and other KPI-related information.

In 704, process monitoring tool 110 may determine if the KPIs retrieved in 602 have been iterated through, i.e. the KPIs have had a priority calculated. If all KPIs have been iterated through, then method 700 proceeds to 714. If KPIs remain to examine then method 700 proceeds to 706.

In 706, process monitoring tool 110 may step to, consider, or load the next KPI from among the KPIs retrieved in 702. The order in which the KPIs are traversed is flexible, and KPIs may be traversed in any suitable order. This retrieved KPI may be referred to below as the current KPI.

In 708, process monitoring tool 110 may calculate a KPI prevalence. A KPI prevalence may be calculated by considering the number of processes that the KPI is assigned to across the monitored processes. This KPI prevalence may be referred in calculations below as N:
N=Number of Processes Containing The Current KPI

In 710, process monitoring tool 110 may also calculate a status indicator. This indicator may consider the status of the KPI (as recently refreshed from ancillary systems 130, infrastructure components 140 and/or data source 150) as well as a category assigned to the KPI at design time. In an embodiment, the status indicator may be determined by looking up the status and category in an appropriately designed matrix. An example of such a matrix is displayed above with reference to FIG. 5. This value may be referred to below as the current status:

current status=f(Status,Category)

In 712, process monitoring tool 110 may calculate a KPI priority. An initial KPI priority may be derived by multiplying N by the current status indicator. The initial KPI priority may be:

W_{KPI}=N×f(Status,Category)

The initial KPI may be further modified by multiplying the initial KPI by a KPI preference set at design time. The KPI preference may differ across the examined KPIs, as determined by user 102 when configuring the KPI at design time. A KPI preference may be set in textual or numerical values. Example matrices for determining a value for a KPI preference are included above with reference to FIG. 5. Thus the KPI priority may additionally consider the KPI preference (KPI_{Pref}) to determine the KPI priority:

W′_{KPI}=(W_{KPI}*KPI_{Pref})

In 714, process monitoring tool 110 may sort the KPIs by the KPI priority determined in 712 and break any ties. Process monitoring tool 110 may use any suitable sorting method to sort the KPIs by their calculated priorities. Process monitoring tool 110 may break ties by, for example, considering if an open support ticket exists for the KPI. If the tie remains, process monitoring tool 110 may consider the order in which the KPI was added, the time of the most recent refresh, alphabetical order, or any other suitable approach to break ties.

In 716, process monitoring tool 110 may display the sorted KPIs processes according to the KPI priorities determined in 712. Process monitoring tool 110 may invoke interface elements 112 and/or responsive agent 114 to form an appropriate visualization of the sorted KPIs. Thus, user 102 may view the KPIs in process monitoring tool 110 sorted by an indication of priority that considers the status, category, prevalence, and preference for all KPIs employed in process monitoring tool 110.

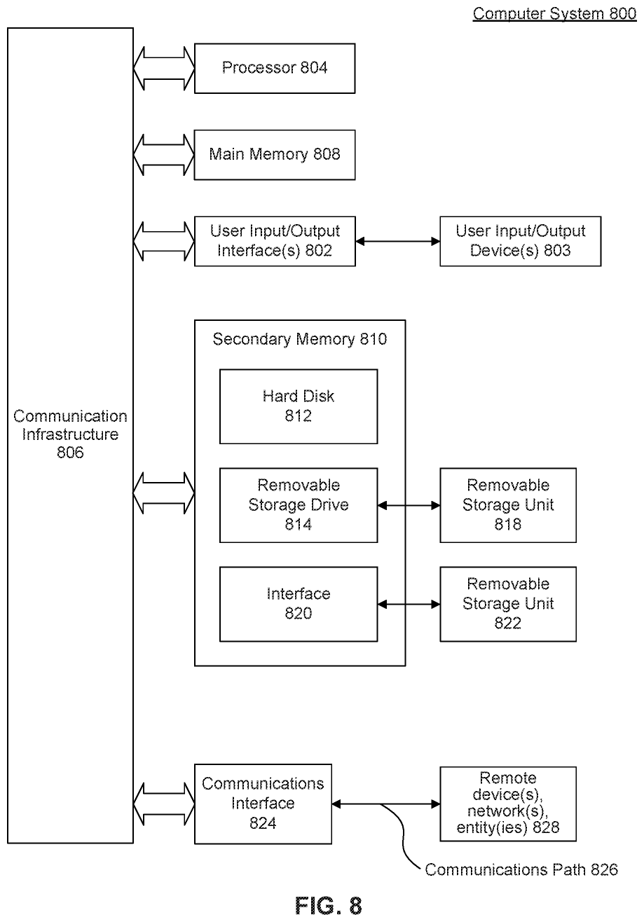

FIG. 8 is an example computer system useful for implementing various embodiments. Various embodiments may be implemented, for example, using one or more well-known computer systems, such as computer system 800 shown in FIG. 8. One or more computer systems 800 may be used, for example, to implement any of the embodiments discussed herein, as well as combinations and sub-combinations thereof.

Computer system 800 may include one or more processors (also called central processing units, or CPUs), such as a processor 804. Processor 804 may be connected to a communication infrastructure or bus 806.

Computer system 800 may also include user input/output device(s) 802, such as monitors, keyboards, pointing devices, etc., which may communicate with communication infrastructure or bus 806 through user input/output device(s) 802.

One or more of processors 804 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 may also include a main or primary memory 808, such as random access memory (RAM). Main memory 808 may include one or more levels of cache. Main memory 808 may have stored therein control logic (i.e., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 may include a computer usable or readable storage device having stored thereon computer software (control logic) and/or data. Removable storage unit 818 may be a floppy disk, magnetic tape, compact disk, DVD, optical storage disk, and/any other computer data storage device. Removable storage drive 814 may read from and/or write to removable storage unit 818.

Secondary memory 810 may include other means, devices, components, instrumentalities or other approaches for allowing computer programs and/or other instructions and/or data to be accessed by computer system 800. Such means, devices, components, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 may enable computer system 800 to communicate and interact with any combination of external devices, external networks, external entities, etc. (individually and collectively referenced by reference number 828). For example, communication interface 824 may allow computer system 800 to communicate with external or remote devices 828 over communications path 826, which may be wired and/or wireless (or a combination thereof), and which may include any combination of LANs, WANs, the Internet, etc. Control logic and/or data may be transmitted to and from computer system 800 via communication path 826.

Computer system 800 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 800 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 800 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 8. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method, comprising:
retrieving, by a process monitoring tool, one or more processes comprising a process preference and one or more key performance indicators (KPIs) each comprising a KPI preference, a status, and a category;
determining, by the process monitoring tool, a process priority for each of the one or more processes wherein the determining comprises iterating through the one or more processes and for each process:
(1) iterating through each of the one or more KPIs assigned to the process and for each KPI calculating a KPI priority by:
(a) calculating a KPI prevalence, wherein the KPI prevalence is a number of associated processes to which the KPI is assigned,
(b) calculating a KPI status indicator, wherein the KPI status indicator is determined based on the category and the status, and
(c) calculating the KPI priority by multiplying the KPI prevalence by the KPI status indicator by the KPI preference, and
(2) calculating a process priority for the process by summing the KPI priority across the one or more KPIs and multiplying the sum by the process preference; and
displaying, by the process monitoring tool, the one or more processes sorted by the determined process priority for each of the one or more processes,
wherein at least one of the retrieving, determining, iterating, calculating, and displaying are performed by one or more computers.

2. The method of claim 1, further comprising:
receiving, by the process monitoring tool, a selected process from among the one or more processes; and
displaying, by the process monitoring tool, the one or more KPIs assigned to the selected process sorted by the KPI priority for the one or more KPIs assigned to the selected process.

3. The method of claim 1, further comprising:
displaying, by the process monitoring tool, a list of all KPIs in the process monitoring tool sorted by the calculated KPI priority.

4. The method of claim 1, the displaying the one or more processes further comprising:
assigning, by the process monitoring tool, a color indicator to the KPI status indicator for each KPI;
grouping, by the process monitoring tool, each KPI into a color group based on the color indicator; and
displaying, by the process monitoring tool, the KPIs in an ordered form based on the color group.

5. The method of claim 1, the calculating the KPI status indicator further comprising:
retrieving, by the process monitoring tool, a default matrix; and
determining, by the process monitoring tool, the KPI status by comparing the category and status to a row and a column in the default matrix.

6. The method of claim 1, further comprising:
associating, by the process monitoring tool, a threshold with the one or more key performance indicators; and
determining, by the process monitoring tool, the status based on the threshold.

7. The method of claim 1, wherein the process monitoring tool monitors a cloud solution providing cloud services to multiple customers.

8. A system, comprising:
a memory; and
at least one processor coupled to the memory, the at least one processor configured to:
retrieve one or more processes in a process monitoring tool comprising a process preference and one or more key performance indicators (KPIs) each comprising a KPI preference, a status, and a category;
determine a process priority for each of the one or more processes by iterating through the one or more processes and for each process:
(1) iterate through each of the one or more KPIs assigned to the process and for each KPI calculate a KPI priority wherein to calculate the KPI priority, the at least one processor is configured to:
(a) calculate a KPI prevalence, wherein the KPI prevalence is a number of associated processes to which the KPI is assigned,
(b) calculate a KPI status indicator, wherein the KPI status indicator is determined based on the category and the status, and
(c) calculate the KPI priority by multiplying the KPI prevalence by the KPI status indicator by the KPI preference, and
(2) calculate a process priority for the process by summing the KPI priority across the one or more KPIs and multiplying the sum by the process preference; and
display the one or more processes sorted by the determined process priority for each of the one or more processes.

9. The system of claim 8, the at least one processor further configured to:
receive a selected process from among the one or more processes; and
display the one or more KPIs assigned to the selected process sorted by the KPI priority for the one or more KPIs assigned to the selected process.

10. The system of claim 8, the at least one processor further configured to:
display a list of all KPIs in the process monitoring tool sorted by the KPI priority for the one or more KPIs.

11. The system of claim 8, wherein to display the one or more processes, the at least one processor is configured to:
assign a color indicator to the KPI status indicator for each KPI;
group each KPI into a color group based on the color indicator; and
display the KPIs in an ordered form based on the color group.

12. The system of claim 8, wherein a KPI in the one or more KPIs can be a technical KPI monitoring a technical resource or a KPI tracking a process efficiency.

13. The system of claim 8, wherein the KPI preference can be one of: numerical and textual.

14. The system of claim 8, wherein the process monitoring tool monitors a cloud solution providing cloud services to multiple customers.

15. A non-transitory computer-readable device having instructions stored thereon that, when executed by at least one computing device, cause the at least one computing device to perform operations comprising:
retrieving one or more processes in a process monitoring tool comprising a process preference and one or more key performance indicators (KPIs) each comprising a KPI preference, a status, and a category;
determining a process priority for each of the one or more processes wherein the determining comprises iterating through the one or more processes and for each process:
(1) iterating through each of the one or more KPIs assigned to the process and for each KPI calculating a KPI priority by:
(a) calculating a KPI prevalence, wherein the KPI prevalence is a number of associated processes to which the KPI is assigned,
(b) calculating a KPI status indicator, wherein the KPI status indicator is determined based on the category and the status, and
(c) calculating the KPI priority by multiplying the KPI prevalence by the KPI status indicator by the KPI preference, and
(2) calculating a process priority for the process by summing the KPI priority across the one or more KPIs and multiplying the sum by the process preference; and
displaying the one or more processes sorted by the determined process priority for each of the one or more processes.

16. The non-transitory computer-readable device of claim 15, the operations further comprising:
receiving a selected process from among the one or more processes; and
displaying the one or more KPIs assigned to the selected process sorted by the KPI priority for the one or more KPIs assigned to the selected process.

17. The non-transitory computer-readable device of claim 15, the operations further comprising:
displaying a list of all KPIs in the process monitoring tool sorted by the calculated KPI priority.

18. The non-transitory computer-readable device of claim 15, the operations further comprising:
assigning a color indicator to the KPI status indicator for each KPI;
grouping each KPI into a color group based on the color indicator; and
displaying the KPIs in an ordered form based on the color group.

19. The non-transitory computer-readable device of claim 15, the operations further comprising:
associating a threshold with the one or more key performance indicators; and
determining the status based on a threshold.

20. The non-transitory computer-readable device of claim 15, wherein the process monitoring tool monitors a cloud solution providing cloud services to multiple customers.
